(19) United States
(12) Patent Application Publication
(10) Pub. No.: US 2021/0276700 A1
(43) Pub. Date: Sep. 9, 2021

(54) CONTROL METHOD AND DEVICE FOR UNMANNED AERIAL VEHICLE, AND UNMANNED AERIAL VEHICLE

(71) Applicant: SZ DJI TECHNOLOGY CO., LTD., Shenzhen (CN)

(72) Inventors: Wenlin XIE, Shenzhen (CN); Yanchen LIU, Shenzhen (CN); Zihan CHEN, Shenzhen (CN)

(21) Appl. No.: 17/149,062

(22) Filed: Jan. 14, 2021

Related U.S. Application Data
(63) Continuation of application No. PCT/CN2018/097664, filed on Jul. 27, 2018.

(51) Int. Cl. B64C 25/32; B64C 39/02; B64D 47/08; G05D 1/00; G03B 15/00; G03B 17/56

(52) U.S. Cl. CPC B64C 25/32; B64C 39/024; B64D 47/08; B64C 2201/127; G03B 15/006; G03B 17/561; G05D 1/0094

(57) ABSTRACT

A control method includes, when a landing gear of an unmanned aerial vehicle (UAV) is at a zero position, controlling a yaw-axis motor of a gimbal of the UAV to rotate to different positions according to a specific strategy that includes the landing gear following the yaw-axis motor to rotate synchronously, determining an angle relationship parameter between a landing gear motor of the UAV and the yaw-axis motor by controlling the yaw-axis motor to rotate to the different positions, in a mode where the landing gear follows the yaw-axis to rotate, obtaining a real-time rotation angle of the yaw-axis motor, and controlling rotation of the landing gear motor according to the angle relationship parameter and the real-time rotation angle of the yaw-axis motor.

### CROSS-REFERENCE TO RELATED APPLICATION

This application is a continuation of International Application No. PCT/CN2018/097664, filed Jul. 27, 2018, the entire content of which is incorporated herein by reference.

### TECHNICAL FIELD

The present disclosure relates to the field of control of unmanned aerial vehicles (UAVs) and, more particularly, to a control method and a control device for a UAV, and a UAV.

### BACKGROUND

In the existing technologies, in order to prevent a landing gear of the UAV from entering a shooting frame of a shooting device mounted at the UAV, the position of the landing gear is adjusted by controlling a rotation of a landing gear motor, and a determination is made by human visual inspection about whether the landing gear and a gimbal yaw axis are aligned. Specifically, the landing gear motor and the landing gear are connected through a transmission component such as a belt or a gear, so that the landing gear motor drives the landing gear to rotate. Because of influences from factors such as materials of belts or gears, installation deviations, etc., the rotation of the landing gear has deviations. As time goes by, the offset of the landing gear from the yaw axis of the gimbal increases, resulting in a larger portion of the landing gear appearing in the shooting frame and interfering with aerial photography.

### SUMMARY

In accordance with the disclosure, there is provided a control method including, when a landing gear of an unmanned aerial vehicle (UAV) is at a zero position, controlling a yaw-axis motor of a gimbal of the UAV to rotate to different positions according to a specific strategy that includes the landing gear following the yaw-axis motor to rotate synchronously, determining an angle relationship parameter between a landing gear motor of the UAV and the yaw-axis motor by controlling the yaw-axis motor to rotate to the different positions, in a mode where the landing gear follows the yaw-axis to rotate, obtaining a real-time rotation angle of the yaw-axis motor, and controlling rotation of the landing gear motor according to the angle relationship parameter and the real-time rotation angle of the yaw-axis motor.

Also in accordance with the disclosure, there is provided a control device for an unmanned aerial vehicle (UAV) including a gimbal configured to carry a photographing device and including a yaw-axis motor, a landing gear motor configured to drive a landing gear of the UAV to rotate, and one or more processors electrically connected to the landing gear motor and the yaw-axis motor, and configured to, individually or collectively, when the landing gear is at a zero position, control the yaw-axis motor to rotate to different positions according to a specific strategy that includes the landing gear following the yaw-axis motor to rotate synchronously, determine an angle relationship parameter between the landing gear motor and the yaw-axis motor by controlling the yaw-axis motor to rotate to the different positions, in a mode where the landing gear follows the yaw-axis to rotate, obtain a real-time rotation angle of the yaw-axis motor, and control the rotation of the landing gear motor according to the first parameter and the real-time rotation angle of the yaw-axis motor.

Also in accordance with the disclosure, there is provided an unmanned aerial vehicle (UAV) including a frame assembly, a gimbal mounted at the frame assembly, configured to carry a photographing device, and including a yaw-axis motor, a landing gear including a landing gear motor configured to drive the landing gear to rotate, and a processor electrically connected to the yaw-axis motor and the landing gear motor and configured to, when the landing gear is at a zero position, control the yaw-axis motor to rotate to different positions according to a specific strategy that includes the landing gear following the yaw-axis motor to rotate synchronously, determine an angle relationship parameter between the landing gear motor and the yaw-axis motor by controlling the yaw-axis motor to rotate to the different positions, in a mode where the landing gear follows the yaw-axis to rotate, obtain a real-time rotation angle of the yaw-axis motor, and control the rotation of the landing gear motor according to the first parameter and the real-time rotation angle of the yaw-axis motor.

### BRIEF DESCRIPTION OF THE DRAWINGS

To more clearly illustrate the technical solution of the present disclosure, the accompanying drawings used in the description of the disclosed embodiments are briefly described below. It is obvious that the drawings described below are merely some embodiments of the present disclosure. Other drawings may be derived from such drawings by a person with ordinary skill in the art without creative efforts.

FIG. 1 is a structural diagram of an unmanned aerial vehicle (UAV) according to an embodiment of the present disclosure.

FIG. 2 is a schematic flow chart of a control method for a UAV according to an embodiment of the present disclosure.

FIG. 3 is a specific schematic flow chart of a control method for a UAV according to an embodiment of the present disclosure.

FIG. 4 is another specific schematic flow chart of a control method for a UAV according to an embodiment of the present disclosure.

FIG. 5 is another specific schematic flow chart of a control method for a UAV according to an embodiment of the present disclosure.

FIG. 6 is a structural block diagram of a control device for a UAV according to an embodiment of the present disclosure.

FIG. 7 is a structural block diagram of a UAV according to an embodiment of the present disclosure.

FIG. 8 is another structural block diagram of a UAV according to an embodiment of the present disclosure.

FIG. 9 is another structural block diagram of a UAV according to an embodiment of the present disclosure.

### REFERENCE NUMERALS

100-Frame Assembly, 200-Gimbal, 210-Yaw-Axis Motor, 300-Landing Gear, 310-Landing Gear Motor, 320-Support Rod, 400-Photographing Device, 500-Processor, 600-Power Mechanism, 700-External Device, 710-Terminal, 720-Remote Controller, 800-First Sensing Device, 900-Second Sensing Device.

### DETAILED DESCRIPTION OF THE EMBODIMENTS

The technical solutions in the example embodiments of the present disclosure will be described clearly and completely with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

A control method and a control device for an unmanned aerial vehicle (UAV), and a UAV will be described in detail with reference to the accompanying drawings. In the case of no conflict, the following embodiments and the features in the embodiments can be combined with each other.

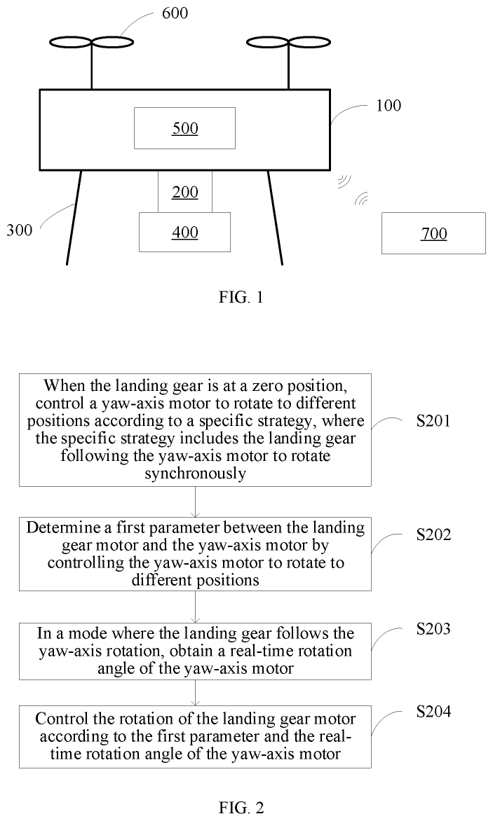

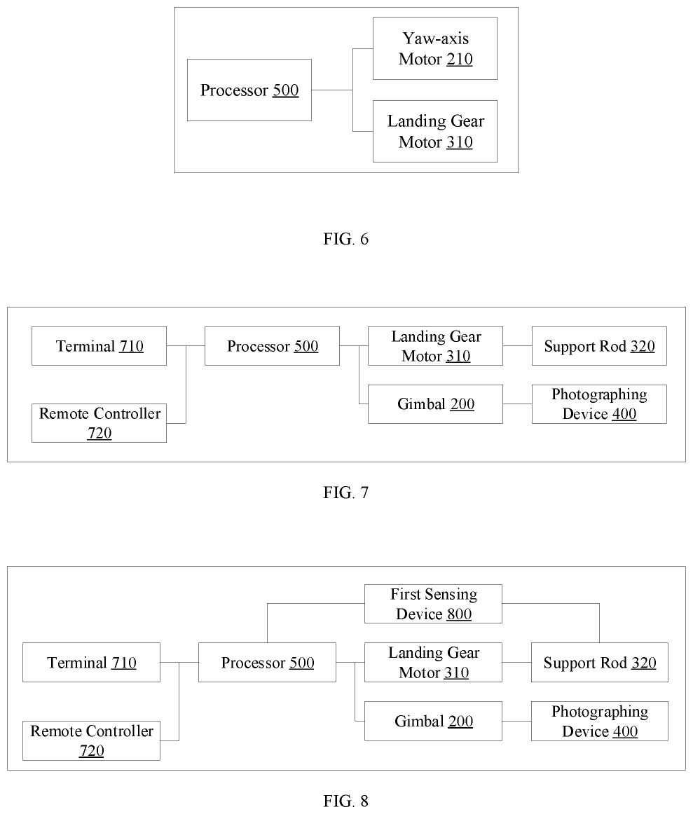

FIG. 1 is a schematic structural diagram of a UAV according to an embodiment of the present disclosure. The UAV includes a frame assembly 100, a gimbal 200 mounted at the frame assembly 100, and a landing gear 300, where the gimbal 200 is used to carry a photographing device 400. With reference to FIG. 6, the gimbal 200 of the embodiments includes a yaw axis and a yaw-axis motor 210 for driving the yaw axis to rotate. Further, the gimbal 200 of the embodiments may be a two-axis gimbal or a three-axis gimbal. The photographing device 400 may be an image capture device or a camera device (such as a camera, a camcorder, an infrared camera device, an ultraviolet camera device or the like), an audio capture device (for example, a parabolic reflective microphone), or an infrared camera device, etc. The photographing device 400 can provide static sensing data (such as images) or dynamic sensing data (such as videos). The photographing device 400 is mounted at the gimbal 200, so that the gimbal 200 controls the rotation of the photographing device 400. With reference to FIGS. 7-9, the landing gear 300 includes a landing gear motor 310 for driving the landing gear to rotate (specifically, the landing gear 300 includes a plurality of support rods 320, and the landing gear motor 310 is used to drive one or more of them to rotate). When the UAV is landing, the landing gear 300 is holding on the landing surface to ensure a safe landing of the UAV.

With further reference to FIGS. 7-9, the UAV of the embodiments further includes a processor 500, and the processor 500 may include one or more. For example, in some embodiments, the processor 500 is a flight controller. In some other embodiments, the processor 500 includes a flight controller and a gimbal controller, and the flight controller and the gimbal controller cooperate with each other. In some other embodiments, the processor 500 may be an independently configured controller. The embodiments do not specifically limit the type of the processor 500.

In the embodiments, the processor 500 may control the rotation of the gimbal 200, so as to control the attitude of the photographing device 400. The yaw-axis motor 210 of the embodiments is in communication connection with the processor 500, for example, based on a controller area network (CAN) bus or another communication connection manner. The rotation of the yaw-axis motor 210 can be controlled by the processor 500 to control the rotation of the yaw axis. In addition, in some embodiments, the photographing device 400 is in communication connection with the processor 500, for example, the photographing device 400 is in communication connection with the processor 500 directly, or the photographing device 400 is in communication connection with the processor 500 through the gimble 200. The processor 500 may be used to control the operation of the photographing device 400 to obtain a shot image from the photographing device 400.

Further, the landing gear motor 310 is electrically connected to the processor 500 to realize a communication between the landing gear motor 310 and the yaw-axis motor 210. In the embodiments, the processor 500 and the landing gear motor 310 cooperate to drive the landing gear to rotate. Optionally, the landing gear 300 includes a plurality of support rods 320, for example, three, four, or five, etc. The plurality of support rods 320 in the embodiments are distributed around the gimbal 200 and the photographing device 400. A landing gear 300 including three support rods 320 is taken as an example for further description.

In some embodiments, there is one landing gear motor 310 for controlling the rotation of the three support rods 320. For example, one landing gear motor 310 can control the three support rods 320 to rotate synchronously, or one landing gear motor 310 can control any support rod 320 to rotate. In some embodiments, there are three landing gear motors 310 for controlling the rotation of the corresponding support rod 320. In addition, the type of the landing gear motor 310 can be selected as needed. For example, the landing gear motor 310 can be a servo motor.

Further, referring to FIG. 8, the UAV of this embodiment further includes a first sensing device 800 for detecting an actual rotation angle of the landing gear 300, and the first sensing device 800 is electrically connected to the processor 500. In the embodiments, the first sensing device 800 is a position sensor or an angle sensor. Optionally, the first sensing device 800 is a position sensor, and the position sensor is a Hall sensor. Here, the Hall sensor may include a Hall switch and a magnet to cooperate with the Hall switch. The Hall switch can be fixed at the frame assembly 100, and the magnet can be disposed at any support rod 320 of the landing gear 300.

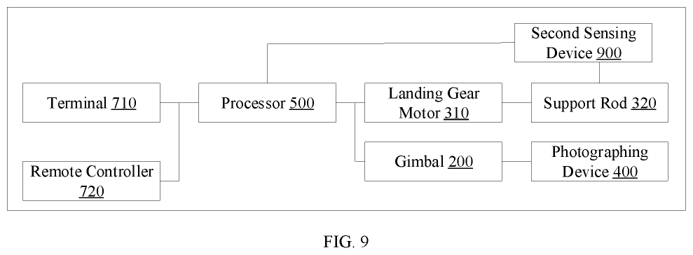

Further, referring to FIG. 9, the UAV of this embodiment further includes a second sensing device 900 for detecting a relative positional relationship between the landing gear 300 and the yaw axis of the gimbal 200, and the second sensing device 900 is electrically connected to the processor 500. In the embodiments, the second sensing device 900 is a position sensor or an angle sensor. Optionally, the second sensing device 900 is a position sensor, and the position sensor is a Hall sensor. Here, the Hall sensor may include a Hall switch and a magnet to cooperate with the Hall switch. The Hall switch can be fixed at the frame assembly 100, and the magnet can be disposed at any support rod 320 of the landing gear 300.

Optionally, the first sensing device 800 and the second sensing device 900 are the same device. Optionally, the first sensing device 800 and the second sensing device 900 are different devices.

Further, the UAV includes a power mechanism 600. The power mechanism 600 may include one or more rotation bodies, propellers, blades, motors, electronic governors, and the like. For example, the rotation body of the power mechanism 600 may be a self-tightening rotation body, a rotation body assembly, or another rotation body power unit. The UAV may have one or more power mechanisms 600. All power mechanisms 600 may be of the same type. Optionally, one or more power mechanisms 600 may be of different types. The power mechanism 600 can be mounted at the UAV by suitable means, such as by a supporting element (such as a drive shaft). The power mechanism 600 can be mounted at any suitable position of the UAV, such as a top end, a lower end, a front end, a rear end, a side, or any combination thereof. One or more power mechanisms 600 are controlled to control the flight of the UAV.

Referring to FIG. 1, the UAV may be in communication connection with an external device 700, such as a terminal 710 or a remote controller 720. In some embodiments, the terminal 710 may provide control data to one or more of the UAV, the gimbal 200, or the photographing device 400, and receive information (such as the position and/or movement information of the UAV, the gimbal 200 or the photographing device 400, or the data sensed by the photographing device 400, such as image data captured by the photographing device 400) from one or more of the UAV, the gimbal 200, or the photographing device 400. Further, the flight of the UAV can be controlled by the remote controller 720.

In some embodiments, the UAV can communicate with other remote devices other than the terminal 710, and the terminal 710 can also communicate with other remote devices other than the UAV. For example, the UAV and/or the terminal 710 may communicate with another UAV or a gimbal 200 or a photographing device 400 of another UAV. When needed, the additional remote device may be a second terminal 710 or another computing device (such as a computer, a desktop computer, a tablet computer, a smart phone, or another mobile device). The remote device can transmit data to the UAV, receive data from the UAV, transmit data to the terminal 710, and/or receive data from the terminal 710. Optionally, the remote device can be connected to an Internet or another telecommunication network, so that data received from the UAV and/or terminal 710 can be uploaded to a website or a server.

In some embodiments, a movement of the UAV, a movement of the gimbal 200, a movement of the photographing device 400 relative to a fixed reference object (such as an external environment), and/or a movement between each other can all be controlled by the terminal 710. The terminal 710 may be a remote control terminal 710, which is located away from the UAV, the gimbal 200 and/or the photographing device 400. The terminal 710 may be located at or pasted at a support platform. Optionally, the terminal 710 may be handheld or wearable. For example, the terminal 710 may include a smart phone, a tablet computer, a desktop computer, a computer, glasses, gloves, a helmet, a microphone, or any combination thereof. The terminal 710 may include a user interface, such as a keyboard, a mouse, a joystick, a touch screen, or a display. Any suitable user input may interact with the terminal 710, such as a manual input instruction, a voice control, a gesture control, or a position control (for example, through a movement, a position, or a tilt of the terminal 710).

FIG. 2 is a flow chart of a control method of a UAV according to some embodiments of the present disclosure. The execution entity of the UAV control method in this embodiment is the UAV, such as a processor 500 of the UAV. As shown in FIG. 2, the method includes the following processes.

At S201, when the landing gear 300 is at a zero position, a yaw-axis motor 210 is controlled to rotate to different positions according to a specific strategy, where the specific strategy includes the landing gear 300 following the yaw-axis motor 210 to rotate synchronously.

In this process, the landing gear 300 and the yaw-axis motor 210 rotate synchronously. For example, the landing gear 300 can be fixed to the yaw axis by a mechanical locking manner. When the yaw-axis motor 210 drives the yaw axis to rotate, the landing gear 300 rotates synchronously. Further, the specific strategy further includes controlling a landing gear motor 310 to be powered on, and controlling an output torque of the landing gear motor 310 to be zero. In this embodiment, linear velocities of the landing gear motor 310 and the yaw-axis motor 210 are the same, but angular velocities are different, so it is needed to further determine a rotation angle relationship between the landing gear motor 310 and the yaw-axis motor 210.

Because of influences from factors such as materials of belts or gears, installation deviations, etc., the rotation of the landing gear has deviations. As time goes by, the offset of the landing gear from the yaw axis of the gimbal increases, resulting in a larger portion of the landing gear appearing in the shooting frame and interfering with aerial photography.

Because of influences from factors such as the material and installation deviation of a belt or gear used to connect the landing gear motor 310 and the landing gear 300, a rotation deviation of the landing gear motor 310 (reflected in a deviation of the landing gear 300 relative to the yaw axis) may be different at a different rotation position of the landing gear motor 310. For example, when the landing gear motor 310 rotates one turn, at the rotation intervals of 0-30°, 30°-90°, 90°-180°, 180°-360°, the rotation deviations of the landing gear motor 310 are different, which affects a first parameter between the landing gear motor 310 and the yaw-axis motor 210 (the first parameter is a rotation angle relationship between the landing gear motor 310 and the yaw-axis motor 210 and is also referred to as an “angle relationship parameter,” and the first parameter is determined at process S202). If a number of turns of rotation of the motor at process S201 is less than one, the first parameter determined at process S202 is inaccurate. That is, the number of turns of rotation of the motor at process S201 affects the accuracy of the first parameter determined at process S202. In this embodiment, at S201, the yaw-axis motor 210 is controlled to rotate at least one turn according to the specific strategy. For example, the number of turns of rotation of the yaw-axis motor 210 may be 1 turn, 1.5 turns, 2 turns, 2.5 turns, 3 turns, 4 turns, or more. The bigger the number of turns of rotation of the motor at process S201, the more accurate the first parameter determined at process S202. When the number of turns of rotation of the motor at process S201 is greater than one, the first parameter determined in the first turn of rotation of the motor can be calibrated according to the first parameter determined in the rotation after the first turn of rotation of the motor.

In addition, before process S201 is performed, it is needed to control the landing gear 300 to be at the zero position, and there may be multiple manners to control the landing gear 300 to be at the zero position. For the implementation manner of controlling the landing gear 300 to be at the zero position, reference can be made to process S203 in the following embodiments.

At S202, the first parameter between the landing gear motor 310 and the yaw-axis motor 210 is determined by controlling the yaw-axis motor 210 to rotate to the different positions.

In the embodiments, controlling the yaw-axis motor 210 to rotate to the different positions according to the specific strategy ensures that the landing gear 300 and the yaw-axis motor 210 rotate synchronously, and excludes the scenario that the landing gear 300 and the yaw-axis motor 210 are not synchronized because of the influence on the rotation of the landing gear 300 from factors such as the material and installation deviation of the belt or gear when the landing gear motor 310 controls the landing gear 300 to follow the yaw-axis motor 210 to rotate synchronously. Then, the first parameter is determined by controlling the yaw-axis motor 210 to rotate to the different positions. In the subsequent process of the UAV aerial photography, the rotation of the landing gear motor 310 is controlled according to the first parameter and the actual rotation angle of the yaw-axis motor 210, therefore the influence on the rotation of the landing gear 300 from factors such as the material and installation deviation of the belt or gear is eliminated, and the landing gear 300 is ensured in a synchronized following state with the yaw axis.

In this process, the first parameters can be determined by collecting angles, or by collecting angular velocities or other parameters. For example, in one embodiment, first rotation angles of the yaw-axis motor 210 and second rotation angles of the landing gear motor 310 are obtained when the yaw-axis motor 210 rotates to the different positions, and the first parameter is determined according to the various first rotation angles and the corresponding second rotation angles.

In another embodiment, when the yaw-axis motor 210 rotates to the different positions, a first rotation angular velocity of the yaw-axis motor 210 and a second rotation angular velocity of the landing gear motor 310 are obtained, and the first parameter is determined according to the various first rotation angular velocity and the corresponding second rotational angular velocity.

In the following embodiment, the first parameter is determined by collecting the first rotation angles and the second rotation angle for further description.

In the embodiments, the yaw-axis motor 210 rotates at least one turn, and the turn of the rotation of the yaw-axis motor 210 includes multiple rotation intervals. For example, one turn of the rotation of the yaw-axis motor 210 may include rotation intervals of 0-30°, 30°-90°, 90°-180°, 180°-360°. The method of dividing the turn of the rotation of the yaw-axis motor 210 is not limited to this. Specifically, the turn of the rotation of the yaw-axis motor 210 can be divided into a plurality of rotation intervals according to needs.

In the embodiments, the first rotation angle of the yaw-axis motor 210 and the second rotation angle of the landing gear motor 310 are obtained when the yaw-axis motor 210 rotates to a designated position in each rotation interval. In some embodiments, the first rotation angle of the yaw-axis motor 210 and the second rotation angle of the landing gear motor 310 are collected based on a sensor.

Further, the designated position can also be selected according to needs. For example, the designated position can be a critical position of each rotation interval, such as 30°, 90°, 180°, 360°, and the designated position can also be another position in the rotation interval, such as a middle position of each rotation interval: 15°, 60°, 150°, 270°.

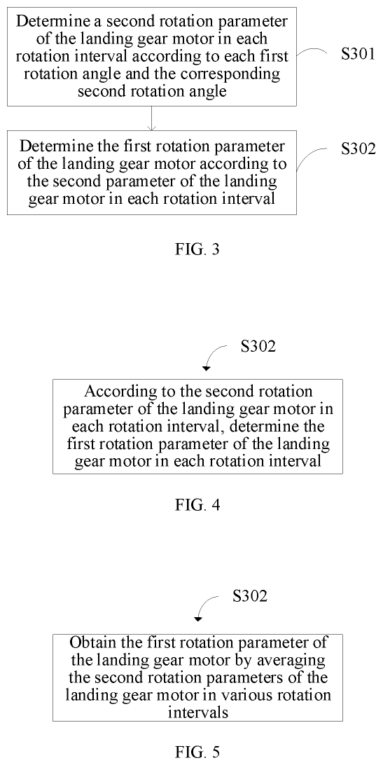

Specifically, referring to FIG. 3, determining the first parameter includes the following processes.

S301: determining a second parameter of the landing gear motor 310 in each rotation interval (that is, a relationship between the rotation angles of the landing gear 310 and the yaw-axis motor 210 in each rotation interval) according to each first rotation angle (that is, a first rotation angle corresponding to each rotation interval) and the corresponding second rotation angle. The second parameter is also referred to an “interval angle relationship parameter.”

S302: determining the first parameter according to the second parameter of the landing gear motor 310 in each rotation interval.

When the second parameter corresponding to each rotation interval is determined, according to a ratio of each first rotation angle to the corresponding second rotation angle, the second parameter of the landing gear motor 310 in each rotation interval is determined. That is, the second parameter of the landing gear motor 310 in each rotation interval =the first rotation angle of the rotation interval/the second rotation angle of the rotation interval.

After the second parameters of multiple rotation intervals are obtained, there may be multiple manners to determine the first parameter of the landing gear motor 310 according to the second parameters of the multiple rotation intervals. For example, in one of the embodiments, as shown in FIG. 4, according to the second parameter of the landing gear motor 310 in each rotation interval, the first parameter of the landing gear motor 310 in each rotation interval is determined. Specifically, when there are n (n is a positive integer and n>1) rotation intervals, the second parameters corresponding to the first rotation interval to the nth rotation interval are k1, k2, . . . kn, respectively. When the yaw-axis motor 210 rotates to the first rotation interval, the first parameter of the landing gear motor 310 is k1, and when the yaw-axis motor 210 rotates to the second rotation interval, the first parameter of the landing gear motor 310 is k2, and so on.

In another embodiment, referring to FIG. 5, the second parameters of the landing gear motor 310 in various rotation intervals are averaged to obtain the first parameter of the landing gear motor 310. When there are n (n is a positive integer and n>1) rotation interval, the second parameters corresponding to the first rotation interval to the nth rotation interval are k1, k2, . . . kn, and the first parameter=(k1+k2+. . . +kn)/n. No matter where the yaw-axis motor 210 rotates to, the first parameter is fixed.

In some other embodiments, other manners may be used to process the second parameters of the landing gear motor 310 in various rotation intervals to determine the first parameter of the landing gear motor 310.

At S203, a real-time rotation angle of the yaw-axis motor 210 is obtained in a mode where the landing gear 300 follows the yaw axis to rotate.

In this embodiment, the yaw-axis motor 210 is provided with an encoder, and the real-time rotation angle of the yaw-axis motor 210 is obtained through the encoder.

In this embodiment, before process S203 is performed, the method further includes controlling the landing gear 300 to be at the zero position, and controlling the gimbal 200 to rotate after the landing gear 300 is at the zero position. When the landing gear 300 is at the zero position, the landing gear 300 does not block the lens of the photographing device 400 or the landing gear 300 blocks the lens less. After the landing gear 300 is at the zero position, the rotation of the gimbal 200 is controlled, so that the rotation of the landing gear motor 310 is controlled according to the rotation of the yaw-axis motor 210 and the first parameter, therefore the standard for the control of the landing gear 300 is unified to ensure the control accuracy of the landing gear 300 and reduce the possibility that the landing gear 300 interferes with shooting.

In some embodiments, the process of controlling the landing gear 300 to be at the zero position is performed immediately after it is determined that the UAV is powered on. In other embodiments, the process of controlling the landing gear 300 to be at the zero position can be performed during the flight of the UAV.

Further, there may be multiple manners to control the landing gear 300 to be at the zero position. For example, in one of the embodiments, the process of controlling the landing gear 300 to be at the zero position may include obtaining zero position information of the landing gear 300, and controlling the landing gear 300 to be at the zero position according to the zero position information. In some embodiments, the zero position information includes a position of the landing gear 300 relative to the gimbal 200 and/or the photographing device 400. Optionally, when the landing gear 300 is at the zero position, the two support rods 320 located at two sides of the photographing device 400 are located at two sides of the photographing device 400 symmetrically about a central axis of the photographing device 400. When the landing gear 300 includes three support rods 320, and further, when the landing gear 300 is at the zero position, the landing gear 300 is aligned with the yaw axis. Specifically, a support rod 320 at a rear end of the photographing device 400 mounted at the gimbal 200 can be controlled to directly face the yaw-axis, so that the landing gear 300 is aligned with the yaw axis. In this situation, the positions of the support rod 320 and the yaw axis coincide with each other.

The zero position information of the landing gear 300 can be pre-stored by a flight controller, or can be obtained from the terminal 710. When the zero position information of the landing gear 300 is pre-stored by the flight controller, the flight controller can directly read the stored zero position information of the landing gear 300 before controlling the landing gear 300 to be at the zero position. For example, when the flight controller determines that the UAV is powered on, the flight controller reads the stored zero position information of the landing gear 300, and controls the landing gear 300 to be at the zero position according to the zero position information of the landing gear 300.

When the zero position information of the landing gear 300 is obtained from the terminal 710, the process of obtaining the zero position information of the landing gear 300 may include firstly, receiving a return-to-zero instruction sent by the terminal 710 that controls the UAV, where the return-to-zero instruction carries the zero position information of the landing gear 300, and then, parsing out the zero position information of the landing gear 300 from the return-to-zero instruction. In this way, the landing gear 300 can be controlled to return to zero during the flight of the UAV, and the manner of controlling the return-to-zero of the landing gear 300 is more flexible.

In another embodiment, the landing gear 300 is provided with a second sensing device 900 for detecting a relative position relationship between the landing gear 300 and the yaw axis of the gimbal 200. The process of controlling the landing gear 300 to be at the zero position in this embodiment may include controlling, through the landing gear motor 310, the landing gear 300 to rotate, obtaining the relative position relationship between the landing gear 300 and the yaw axis of the gimbal 200 detected by the second sensing device 900, and determining that the landing gear 300 is at the zero position when it is determined that the landing gear 300 is aligned with the yaw axis according to the relative position relationship. In this embodiment, it can be determined based on the second sensing device 900 that a support rod 320 at a rear end of the photographing device 400 mounted at the gimbal 200 faces the yaw axis, that is, it can be determined that the landing gear 300 is aligned with the yaw axis. Optionally, when the landing gear 300 is aligned with the yaw axis, the second sensing device 900 outputs a high level, and in other scenarios, the second sensing device 900 outputs a low level. Therefore the output signal of the second sensing device 900 is used to determine whether the landing gear 300 is aligned with the yaw axis, so as to determine whether the landing gear 300 is at the zero position. In this way, the landing gear 300 can be controlled to return to zero during the flight of the UAV, and the manner of controlling the landing gear 300 to return to zero is more flexible.

Furthermore, before the landing gear 300 is controlled to be at the zero position, the method further includes calibrating the zero position of the landing gear 300. In this embodiment, calibration manners for the zero position of the landing gear 300 may include but are not limited to the following manners.

The rotation of the landing gear motor 310 is controlled to adjust the position of the landing gear 300, a relative position relationship between the landing gear 300 and the yaw axis of the gimbal 200 detected by the second sensing device 900 is obtained, current position information of the landing gear 300 is obtained when it is determined that the landing gear 300 is aligned with the yaw axis of the gimbal 200 according to the relative position relationship, and the current position information of the landing gear 300 is marked as the zero position information corresponding to the zero position of the landing gear 300.

In this embodiment, before the rotation of the landing gear motor 310 is controlled to adjust the position of the landing gear 300, a position adjustment instruction sent by the remote controller 720 is received, and according to the position adjustment instruction, the rotation of the landing gear motor 310 is controlled to adjust the position of the landing gear 300. This process is performed during the flight of the UAV.

When the landing gear 300 and the yaw axis of the gimbal 200 are aligned and fixed by a mechanical locking manner, current position information of the landing gear 300 is obtained, and the current position information of the landing gear 300 is marked as the zero position information corresponding to the zero position of the landing gear 300. This process is performed before the UAV flies, that is, the UAV is at a standstill.

Specifically, the UAV is in a stationary state, and a user manually controls the rotation of the landing gear 300 to make the landing gear 300 at the zero position. The landing gear 300 and the yaw axis of the gimbal 200 are aligned and fixed by a mechanical locking manner. Then, the current position information of the landing gear 300 is detected by a sensor, and the current position information is marked as the zero position information of the landing gear 300. In this embodiment, the user manually controls the two support rods 320 located at two sides of the photographing device 400 to be located at two sides of the photographing device 400 symmetrically about a central axis of the photographing device 400, and controls a support rod 320 at a rear end of the photographing device 400 mounted at the gimbal 200 to face the yaw axis, and uses a mechanical locking manner to fix the support rod 320 at the rear end of the photographing device 400 mounted at the gimbal 200 to the yaw axis, so that the landing gear 300 is at the zero position. When the landing gear 300 is at the zero position, it can ensure that the lens of the photographing device 400 is not blocked by the landing gear 300, or even the lens of the photographing device 400 is blocked by the landing gear 300, the landing gear 300 has little effect on the shot image of the photographing device 400. In both scenarios, it is considered that the landing gear 300 has no influence on the shot image of the photographing device 400.

When it is determined that the landing gear 300 does not exist in the shooting frame of the photographing device 400, or it is determined that the landing gear 300 is outside a designated area in the shooting frame of the photographing device 400, the current position information of the landing gear 300 is obtained, and the current position information of the landing gear 300 is marked as the zero position information corresponding to the zero position of the landing gear 300. Based on an image processing algorithm, it can be determined that the landing gear 300 does not exist in the shooting frame of the photographing device 400, or, based on an image processing algorithm, it can be determined that the landing gear 300 is outside a designated area in the shooting frame of the photographing device 400. The landing gear 300 being outside the designated area in the shooting frame of the photographing device 400 includes the landing gear 300 being outside a middle area of the shooting frame. For example, the landing gear 300 is located at the edge of the shooting frame, which does not affect the overall effect of the shooting frame, or the landing gear 300 can be removed from the shooting frame through a post-image processing without affecting the use of the shooting frame. A location and size of the designated area can also be selected according to the specific needs of the user.

In some embodiments, before it is determined that the landing gear 300 does not exist in the shooting frame of the photographing device 400, or it is determined that the landing gear 300 is outside the designated area in the shooting frame of the photographing device 400, the method may include receiving a position adjustment instruction sent by the remote controller 720, and according to the position adjustment instruction, controlling the rotation of the landing gear motor 310 to adjust the position of the landing gear 300, so that the landing gear 300 does not exist in the shooting frame of the photographing device 400, or the landing gear 300 is outside the designated area in the shooting frame of the photographing device 400. This process is performed during the flight of the UAV.

The landing gear 300 and the yaw axis of the gimbal 200 being aligned includes two support rods 320 located at two sides of the photographing device 400 symmetrically locating at two sides of the photographing device 400 along the central axis of the photographing device 400 and/or a support rod 320 at the rear end of the photographing device 400 mounted at the gimbal 200 facing the yaw axis.

In addition, there may be multiple manners to mark the zero position information corresponding to the zero position of the landing gear 300, such as directly storing the zero position information at the processor 500, or storing the zero position information in a storage device of the landing gear motor 310 (such as a flash memory), or sending the zero position information to the terminal 710 or the remote controller 720 and storing the zero position information of the landing gear 300 by the terminal 710 or the remote controller 720. For example, in a specific implementation manner, the zero position information is sent to the terminal 710 that controls the UAV to achieve a zero position calibration of the landing gear 300. When the landing gear 300 needs to be controlled to be at the zero position, a position adjustment instruction carrying the zero position information of the landing gear 300 is sent by the terminal 710 to the UAV, and the UAV controls the landing gear motor 310 to rotate according to the zero position information, so that the landing gear 300 can be at the zero position. Specifically, according to the position adjustment instruction, the rotation of the landing gear motor 310 is controlled to control the two support rods 320 located at two sides of the photographing device 400 mounted at the gimbal 200 to locate at two sides of the photographing device 400 symmetrically about the central axis of the photographing device 400, so that the two support rods 320 located at two sides of the photographing device 400 mounted at the gimbal 200 do not affect the shooting frame of the photographing device 400 too much, thereby achieving a better aerial photography effect. When the landing gear 300 includes three support rods 320, the rotation of the landing gear motor 310 also needs to be controlled according to the position adjustment instructions to control a support rod 320 at the rear end of the photographing device 400 mounted at the gimbal 200 to face the yaw axis to further align the landing gear 300 with the yaw axis, thereby reducing the impact of the landing gear 300 on the shooting of the photographing device 400.

At S204, the rotation of the landing gear motor 310 is controlled according to the first parameter and the real-time rotation angle of the yaw-axis motor 210.

In the process of the UAV aerial photography, the rotation of the landing gear motor 310 is controlled according to the first parameter and the actual rotation angle of the yaw-axis motor 210, therefore the influence on the rotation of the landing gear 300 from factors such as the material and installation deviation of the belt or gear is eliminated, and the landing gear 300 is ensured in a synchronized following state with the yaw axis.

Process S201 specifically includes determining a target rotation angle of the landing gear motor 310 according to the first parameter and the real-time rotation angle of the yaw-axis motor 210, and controlling the landing gear motor 310 to rotate according to the target rotation angle. Specifically, in this embodiment, the process of determining the target rotation angle of the landing gear motor 310 includes determining a target angle of the landing gear 300 according to the real-time rotation angle of the yaw-axis motor 210, and multiplying the first parameter and the target angle to determine the target rotation angle of the landing gear motor 310, that is, the target angle of the landing gear motor 310=the first parameter×the target angle of the landing gear 300. If the rotation of the landing gear motor 310 is directly controlled according to the target angle of the landing gear 300, there will be deviation in the actual position of the landing gear 300 because of the influence from factors such as the material and installation deviation of a belt or gear used to connect the landing gear motor 310 and the landing gear 300, and the position deviation of the landing gear 300 will become larger and larger as time goes by. In this embodiment, the target angle of the landing gear 300 is corrected by using the first parameter to obtain the target angle of the landing gear motor 310, thereby achieving a precise control of the landing gear 300 and ensuring the alignment of the landing gear 300 and the yaw axis.

In addition, in this embodiment, when the rotation of the landing gear motor 310 is controlled, firstly, according to the target rotation angle, a drive signal of the landing gear motor 310 is generated, and then the drive signal is sent to the landing gear motor 310, therefore the rotation of the landing gear motor 310 is controlled to control the rotation of the landing gear 300, so that the landing gear 300 rotates synchronously with the yaw axis (that is, the landing gear 300 and the yaw axis remain relatively stationary).

After the drive signal is sent to the landing gear motor 310, the method may further include obtaining the actual rotation angle of the landing gear 300 based on the first sensing device 800, and adjusting the drive signal according to the actual rotation angle. A precise control of the landing gear motor 310 is achieved through a closed loop to precisely control the rotation of the landing gear 300.

Further, before the drive signal is adjusted according to the actual rotation angle, the method may further include determining that a difference between the actual rotation angle and the target rotation angle is less than a preset threshold (for example, 0.5°) to ensure a normal rotation of the landing gear motor 310, thereby precisely controlling the rotation of the landing gear 300. During the operation of the landing gear motor 310, obstacles may occur, resulting in a large rotation error of the landing gear motor 310. In this situation, the landing gear motor 310 is in an abnormal working state, and the actual rotation angle has a large error. A precise control of the landing gear motor 310 cannot be achieved by adjusting the drive signal according to the actual angle.

In addition, in this embodiment, a linear interpolation algorithm and/or an S-shaped interpolation algorithm are used to control the rotation of the landing gear motor 310 according to the target rotation angle, so that the landing gear 300 can smoothly rotate while following the yaw axis.

Further, after process S202 and before process S203, the method may further include saving the first parameter. For example, the first parameter is saved at the flash memory of the landing gear motor 310, or the first parameter is sent to the terminal 710, and the first parameter is obtained from the terminal 710 in the mode where the landing gear 300 follows the yaw axis.

In an implementation manner, the first parameters are different according to the different rotation intervals of the yaw-axis motor 210. When the first parameter is saved, the first parameter of the landing gear motor 310 in each rotation interval is saved. In this embodiment, the rotation interval of the yaw-axis motor 210 and the first parameter are correspondingly saved. Optionally, the rotation interval of the yaw-axis motor 210 and the first parameter are correspondingly saved in a table. In this implementation manner, after process S203 and before process S204, the method further includes determining a current rotation interval of the yaw-axis motor 210 according to the real-time rotation angle of the yaw-axis motor 210, obtaining the corresponding first parameter according to the current rotation interval, and realizing a precise control of the landing gear 300 by controlling the rotation of the landing gear motor 310 according to the real-time rotation interval of the yaw-axis motor 210.

In another embodiment, the first parameter is a same fixed value, and when the first parameter is saved, the fixed value is saved. When process S204 is performed, the fixed value can be directly called.

In the UAV control method of the embodiments of the present disclosure, when the landing gear 300 is at the zero position, the yaw-axis motor 210 is controlled to rotate to the different positions according to a specific strategy, thereby the first parameter is determined between the landing gear motor 310 and the yaw-axis motor 210. During the aerial photography process, the landing gear motor 310 is controlled to rotate according to the first parameter and the real-time rotation angle of the yaw-axis motor 210, so that the landing gear 300 follows the gimbal yaw axis synchronously, which effectively prevents an accumulated error from causing deviation at the alignment position of the landing gear 300 and the yaw axis of the gimbal, thereby preventing the landing gear 300 from entering the image during the shooting while flying. The UAV control method of the embodiments of the present disclosure, different from the existing form of retractable landing gear 300 that relies solely on a semi-closed loop of the steering gear, designs to intelligently follow the gimbal yaw axis, which is convenient for users to take aerial photography.

Referring to FIG. 6, the present disclosure further provides a UAV control device, which includes a gimbal 200 for carrying a photographing device 400, a landing gear motor 310 for driving a landing gear 300 of the UAV to rotate, and a processor 500. The gimbal 200 includes a yaw-axis motor 210, and the processor 500 is electrically connected to the landing gear motor 310 and the yaw-axis motor 210.

The processor 500 may be a central processing unit (CPU). The processor 500 may further include a hardware chip. The foregoing hardware chip may be an application-specific integrated circuit (ASIC), a programmable logic device (PLD), or a combination thereof. The above-mentioned PLD may be a complex programmable logic device (CPLD), a field-programmable gate array (FPGA), a generic array logic (GAL) or any combination thereof.

In this embodiment, there may be one or more processors 500, working individually or collectively. Optionally, the processor 500 may be a combination of one or more of a flight controller, a gimbal controller, or another controller provided at the UAV.

The processor 500 may implement the corresponding methods as shown in the embodiments of FIGS. 2-5 of the present disclosure.

Specifically, the processor 500 is configured to, when the landing gear 300 is at a zero position, control the yaw-axis motor 210 to rotate to different positions according to a specific strategy, where the specific strategy includes the landing gear 300 following the yaw-axis motor 210 to rotate synchronously, determine a first parameter between the landing gear motor 310 and the yaw-axis motor 210 by controlling the yaw-axis motor 210 to rotate to the different positions, in a mode where the landing gear 300 follows the yaw-axis to rotate, obtain a real-time rotation angle of the yaw-axis motor 210, and control the rotation of the landing gear motor 310 according to the first parameter and the real-time rotation angle of the yaw-axis motor 210.

It should be noted that, for the specific implementation of the processor 500 in the embodiments of the present disclosure, reference may be made to the description of the corresponding content in the above-described example method embodiments, which is not repeated here.

In the UAV control device of the embodiments of the present disclosure, when the landing gear 300 is at the zero position, the yaw-axis motor 210 is controlled to rotate to the different positions according to a specific strategy, thereby the first parameter is determined between the landing gear motor 310 and the yaw-axis motor 210. During the aerial photography process, the landing gear motor 310 is controlled to rotate according to the first parameter and the real-time rotation angle of the yaw-axis motor 210, so that the landing gear 300 follows the gimbal yaw axis synchronously, which effectively prevents an accumulated error from causing deviation at the alignment position of the landing gear 300 and the yaw axis of the gimbal, thereby preventing the landing gear 300 from entering the image during the shooting while flying. The UAV control device of the embodiments of the present disclosure, different from the existing form of retractable landing gear 300 that relies solely on a semi-closed loop of the steering gear, designs to intelligently follow the gimbal yaw axis, which is convenient for users to take aerial photography.

The present disclosure further provides a UAV, which includes a frame assembly 100, a gimbal 200 mounted at the frame assembly 100, a landing gear 300, and a processor 500. The gimbal 200 is used for carrying a photographing device 400, and the gimbal of this embodiment includes a yaw-axis motor 210. The landing gear 300 includes a landing gear motor 310, and the landing gear motor 310 is used to drive the landing gear to rotate. The processor 500 of this embodiment is electrically connected to the yaw-axis motor 210 and the landing gear motor 310.

The processor 500 may be a central processing unit (CPU). The processor 500 may further include a hardware chip. The foregoing hardware chip may be an application-specific integrated circuit (ASIC), a programmable logic device (PLD), or a combination thereof. The above-mentioned PLD may be a complex programmable logic device (CPLD), a field-programmable gate array (FPGA), a generic array logic (GAL) or any combination thereof.

In this embodiment, there may be one or more processors 500, working individually or collectively. Optionally, the processor 500 may be a combination of one or more of a flight controller, a gimbal controller, or another controller provided at the UAV.

The processor 500 may implement the corresponding methods as shown in the embodiments of FIGS. 2-5 of the present disclosure.

Specifically, the processor 500 is configured to, when the landing gear 300 is at a zero position, control the yaw-axis motor 210 to rotate to different positions according to a specific strategy, where the specific strategy includes the landing gear 300 following the yaw-axis motor 210 to rotate synchronously, determine a first parameter between the landing gear motor 310 and the yaw-axis motor 210 by controlling the yaw-axis motor 210 to rotate to the different positions, in a mode where the landing gear 300 follows the yaw-axis to rotate, obtain a real-time rotation angle of the yaw-axis motor 210, and control the rotation of the landing gear motor 310 according to the first parameter and the real-time rotation angle of the yaw-axis motor 210.

Referring to FIG. 8, the UAV of this embodiment further includes a first sensing device 800 for detecting an actual rotation angle of the landing gear 300, and the first sensing device 800 is electrically connected to the processor 500.

Referring to FIG. 9, the UAV of this embodiment further includes a second sensing device 900 for detecting a relative position relationship between the landing gear 300 and a yaw axis of the gimbal 200, and the second sensing device 900 is electrically connected the processor 500.

It should be noted that, for the specific implementation of the processor 500 in the embodiments of the present disclosure, reference may be made to the description of the corresponding content in the above-described example methods embodiments, which is not repeated here.

For the UAV of the embodiments of the present disclosure, when the landing gear 300 is at the zero position, the yaw-axis motor 210 is controlled to rotate to the different positions according to a specific strategy, thereby the first parameter is determined between the landing gear motor 310 and the yaw-axis motor 210. During the aerial photography process, the landing gear motor 310 is controlled to rotate according to the first parameter and the real-time rotation angle of the yaw-axis motor 210, so that the landing gear 300 follows the gimbal yaw axis synchronously, which effectively prevents an accumulated error from causing deviation at the alignment position of the landing gear 300 and the yaw axis of the gimbal, thereby preventing the landing gear 300 from entering the image during the shooting while flying. The UAV of the embodiments of the present disclosure, different from the existing form of retractable landing gear 300 that relies solely on a semi-closed loop of the steering gear, designs to intelligently follow the gimbal yaw axis, which is convenient for users to take aerial photography.

In addition, an embodiment of the present disclosure further provides a computer-readable storage medium on which a computer program is stored. When the program is executed by the processor 500, the processes of the UAV control method consistent with the disclosure, such as one of the example methods, are implemented.

A person of ordinary skill in the art can understand that all or part of the processes in the above-described embodiment methods can be implemented by instructing relevant hardware through a computer program, and the program can be stored in a computer readable storage medium. When the program is executed, it may include the procedures of the above-described method embodiments. The storage medium may be a magnetic disk, an optical disc, a read-only memory (ROM), or a random access memory (RAM), etc.

The above-disclosed are only some of the embodiments of the present disclosure, which should not be used to limit the scope of the present disclosure. Therefore, equivalent changes made according to the claims of the present invention still fall within the scope of the present invention.

What is claimed is:

1. A control method comprising:
when a landing gear of an unmanned aerial vehicle (UAV) is at a zero position, controlling a yaw-axis motor of a gimbal of the UAV to rotate to different positions according to a specific strategy that includes the landing gear following the yaw-axis motor to rotate synchronously;
determining an angle relationship parameter between a landing gear motor of the UAV and the yaw-axis motor by controlling the yaw-axis motor to rotate to the different positions;
in a mode where the landing gear follows the yaw-axis to rotate, obtaining a real-time rotation angle of the yaw-axis motor; and
controlling rotation of the landing gear motor according to the angle relationship parameter and the real-time rotation angle of the yaw-axis motor.

2. The method of claim 1, wherein the specific strategy further includes:
controlling the landing gear motor to be powered on, and controlling an output torque of the landing gear motor to be zero.

3. The method of claim 1, wherein controlling the yaw-axis motor to rotate to the different positions according to the specific strategy includes:
controlling the yaw-axis motor to rotate at least one turn according to the specific strategy.

4. The method of claim 1, wherein determining the angle relationship parameter includes:
obtaining first rotation angles of the yaw-axis motor and second rotation angles of the landing gear motor when the yaw-axis motor rotates to the different positions; and
determining the angle relationship parameter according to the first rotation angles and the second rotation angles.

5. The method of claim 4, wherein:
the yaw-axis motor rotates at least one turn including a plurality of rotation intervals; and
obtaining the first rotation angles of the yaw-axis motor and the second rotation angles of the landing gear motor when the yaw-axis motor rotates to the different positions includes:
obtaining the first rotation angle of the yaw-axis motor and the second rotation angle of the landing gear motor when the yaw-axis motor rotates to a designated position in each one of the plurality of rotation intervals.

6. The method of claim 5, wherein determining the angle relationship parameter includes:
determining an interval angle relationship parameter of the landing gear motor in each of the plurality of rotation intervals according to the corresponding first rotation angle and the corresponding second rotation angle; and
determining the angle relationship parameter according to the interval angle relationship parameters of the landing gear motor in the plurality of rotation intervals.

7. The method of claim 6, wherein determining the interval angle parameter in a rotation interval includes:
determining the interval angle relationship parameter of the landing gear motor in the rotation interval according to a ratio of the corresponding first rotation angle to the corresponding second rotation angle in the rotation interval.

8. The method of claim 6, wherein determining the angle relationship parameter according to the interval angle relationship parameters in the plurality of rotation intervals includes:
setting the interval angle relationship parameter in one of the plurality of rotation intervals as the angle relationship parameter in the one of the plurality of rotation intervals; or
obtaining the angle relationship parameter by averaging the interval angle relationship parameters in the plurality of rotation intervals.

9. The method of claim 5, wherein the designated position of a rotation interval is a critical position of the rotation interval.

10. The method of claim 1, wherein controlling the rotation of the landing gear motor according to the angle relationship parameter and the real-time rotation angle of the yaw-axis motor includes:
determining a target rotation angle of the landing gear motor according to the angle relationship parameter and the real-time rotation angle of the yaw-axis motor; and
controlling the landing gear motor to rotate according to the target rotation angle.

11. The method of claim 10, wherein determining the target rotation angle of the landing gear motor includes:
determining a target angle of the landing gear according to the real-time rotation angle of the yaw-axis motor; and
multiplying the angle relationship parameter and the target angle to determine the target rotation angle of the landing gear motor.

12. The method of claim 10, wherein controlling the landing gear motor to rotate according to the target rotation angle includes:
generating a drive signal of the landing gear motor according to the target rotation angle; and
sending the drive signal to the landing gear motor.

13. The method of claim 12, further comprising, after sending the drive signal to the landing gear motor:
obtaining an actual rotation angle of the landing gear motor based on a sensing device; and
adjusting the drive signal according to the actual rotation angle.

14. The method of claim 13, further comprising, before adjusting the drive signal according to the actual rotation angle:
determining that a difference between the actual rotation angle and the target rotation angle is less than a preset threshold.

15. The method of claim 1, further comprising, before obtaining the real-time rotation angle of the yaw-axis motor:
controlling the landing gear to be at the zero position; and
controlling the gimbal to rotate after the landing gear is at the zero position.

16. The method of claim 15, wherein controlling the landing gear to be at the zero position includes:
obtaining zero position information of the landing gear; and
controlling the landing gear to be at the zero position according to the zero position information.

17. The method of claim 15, wherein controlling the landing gear to be at the zero position includes:
controlling, through the landing gear motor, the landing gear to rotate;
obtaining a relative position relationship between the landing gear and a yaw axis of the gimbal detected by a sensing device; and
determining that the landing gear is at the zero position in response to determining that the landing gear is aligned with the yaw axis of the gimbal according to the relative position relationship.

18. A control device for an unmanned aerial vehicle (UAV) comprising:
a gimbal configured to carry a photographing device and including a yaw-axis motor;
a landing gear motor configured to drive a landing gear of the UAV to rotate; and
one or more processors electrically connected to the landing gear motor and the yaw-axis motor, and configured to, individually or collectively:
when the landing gear is at a zero position, control the yaw-axis motor to rotate to different positions according to a specific strategy that includes the landing gear following the yaw-axis motor to rotate synchronously;
determine an angle relationship parameter between the landing gear motor and the yaw-axis motor by controlling the yaw-axis motor to rotate to the different positions;
in a mode where the landing gear follows the yaw-axis to rotate, obtain a real-time rotation angle of the yaw-axis motor; and
control the rotation of the landing gear motor according to the first parameter and the real-time rotation angle of the yaw-axis motor.

19. The device of claim 18, wherein the one or more processors are further configured to:
obtain first rotation angles of the yaw-axis motor and second rotation angles of the landing gear motor when the yaw-axis motor rotates to the different positions; and
determine the angle relationship parameter according to the first rotation angles and the second rotation angles.

20. An unmanned aerial vehicle (UAV) comprising:
a frame assembly;
a gimbal mounted at the frame assembly and configured to carry a photographing device, the gimbal including a yaw-axis motor;
a landing gear including a landing gear motor configured to drive the landing gear to rotate; and
a processor electrically connected to the yaw-axis motor and the landing gear motor, and configured to:
when the landing gear is at a zero position, control the yaw-axis motor to rotate to different positions according to a specific strategy that includes the landing gear following the yaw-axis motor to rotate synchronously;
determine an angle relationship parameter between the landing gear motor and the yaw-axis motor by controlling the yaw-axis motor to rotate to the different positions;
in a mode where the landing gear follows the yaw-axis to rotate, obtain a real-time rotation angle of the yaw-axis motor; and
control the rotation of the landing gear motor according to the angle relationship parameter and the real-time rotation angle of the yaw-axis motor.
